(19) United States
(12) Patent Application Publication
(10) Pub. No.: US 2026/0110936 A1
(43) Pub. Date: Apr. 23, 2026

(54) Display Device Having a Narrow Bezel Design

(71) Applicant: Dell Products L.P., Round Rock, TX (US)

(72) Inventor: Guentaek Oh, Singapore (SG)

(21) Appl. No.: 18/921,301

(22) Filed: Oct. 21, 2024

(51) Int. Cl. G02F 1/1335; G02F 1/1333; G02F 1/1339

(52) U.S. Cl. CPC G02F 1/133528; G02F 1/133317; G02F 1/1339

(57) ABSTRACT

A display device which includes an optical sheets component and a borderless polarizer system. The borderless polarizer system includes a display cell component, a front polarizer component, the front polarizer component being contiguous with a portion of a top surface of the display cell component and a rear polarizer component, the rear polarizer component being contiguous with a portion of a bottom surface of the display cell component, the front polarizer component and the rear polarizer component providing a polarizer edge, the polarizer edge extending extends along a periphery of the display cell component.

### BACKGROUND OF THE INVENTION

### Field of the Invention

The present invention relates to information handling systems. More specifically, embodiments of the invention relate to information handling system display devices.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

An information handling system display device which includes a narrow substantially borderless bezel is disclosed.

More specifically, in one embodiment the invention relates to a borderless polarizer system for a display device comprising: a display cell component; a front polarizer component, the front polarizer component being contiguous with a portion of a top surface of the display cell component; and, a rear polarizer component, the rear polarizer component being contiguous with a portion of a bottom surface of the display cell component, the front polarizer component and the rear polarizer component providing a polarizer edge, the polarizer edge extending extends along a periphery of the display cell component.

In another embodiment the invention relates to a display device comprising an optical sheets component; and, a borderless polarizer system, the borderless polarizer system comprising a display cell component; a front polarizer component, the front polarizer component being contiguous with a portion of a top surface of the display cell component; and, a rear polarizer component, the rear polarizer component being contiguous with a portion of a bottom surface of the display cell component, the front polarizer component and the rear polarizer component providing a polarizer edge, the polarizer edge extending extends along a periphery of the display cell component.

In another embodiment the invention relates to a system comprising: a processor; a data bus coupled to the processor; and a display device comprising an optical sheets component; and, a borderless polarizer system, the borderless polarizer system comprising a display cell component; a front polarizer component, the front polarizer component being contiguous with a portion of a top surface of the display cell component; and, a rear polarizer component, the rear polarizer component being contiguous with a portion of a bottom surface of the display cell component, the front polarizer component and the rear polarizer component providing a polarizer edge, the polarizer edge extending extends along a periphery of the display cell component.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1, labeled Prior Art, shows a cross sectional view of a portion of a display device.

FIG. 2 shows a general illustration of components of an information handling system as implemented in the present disclosure.

FIG. 3 shows a block diagram of an information handling system configuration and fabrication environment.

FIG. 4 shows a front view of a display device.

FIGS. 5A and 5B, generally referred to as FIG. 5, respectively show a corner view of a portion of a display device and a cross sectional view of a portion of a display device.

FIGS. 6A and 6B, generally referred to as FIG. 6, respectively show a cross sectional perspective view and a cross sectional view of a portion of a display device.

FIGS. 7A and 7B, generally referred to as FIG. 7, respectively show an exploded view of an LCD lighting process and a fanned out view of a polarizer structure of a display device.

FIGS. 8A and 8B, generally referred to as FIG. 8, show operational views of a polarizer structure of a display device.

FIGS. 9A and 9B, generally referred to as FIG. 9, respectively show a corner view of a portion of an alternate display device and a cross sectional view of a portion of an alternate display device.

FIGS. 10A and 10B, generally referred to as FIG. 10, respectively show a cross sectional perspective view and a cross sectional view of a portion of an alternate display device.

### DETAILED DESCRIPTION

Certain aspects of the disclosure reflect an appreciation it is desirable to information handling system display devices with a narrow bezel. Certain aspects of the disclosure reflect an appreciation information handling system display device designs have significantly narrowed their bezel width over subsequent designs. Certain aspects of the disclosure reflect an appreciation that many known information handling system display device panel designs include one or more display device optical components such as a display device light guide plate (LGP).

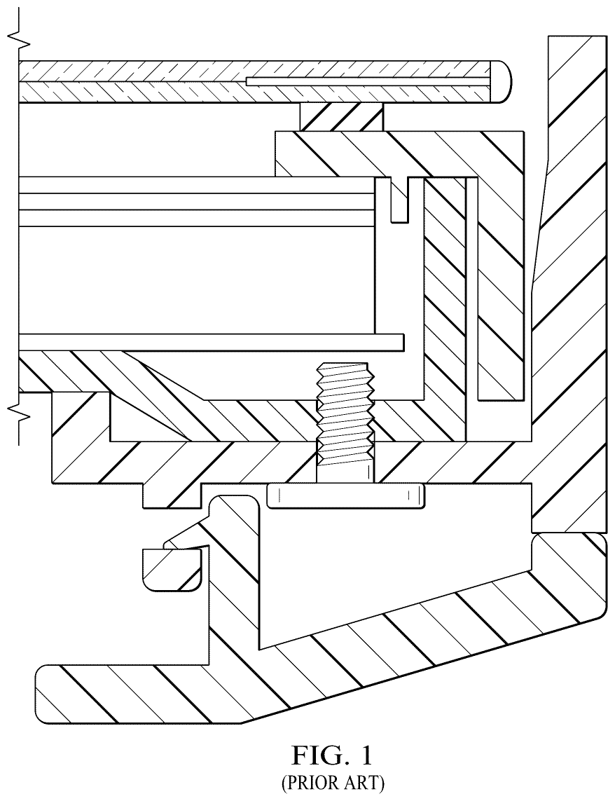

Certain aspects of the disclosure reflect an appreciation that many narrow bezel designs include a gap between the display device outer frame and the display device optical components which extends around the periphery of the display device, referred to as a frame periphery gap. Certain aspects of the disclosure reflect an appreciation that with many narrow bezel designs the gap cannot be smaller than 0.5 mm. Certain aspects of the disclosure reflect an appreciation that with many narrow bezel designs the gap can lead to issues such as trapped dust particles in the gap as well as light leakage through the gap. Certain aspects of the disclosure reflect an appreciation that it would be desirable to minimize the frame periphery gap when designing future information handling system display devices. For example, FIG. 1, labeled Prior Art, shows a cross section of portion of a known display device which includes such a gap.

Various aspects of the present disclosure include an appreciation that a plurality of design factors can affect the width of the frame periphery gap. For example, the middle frame size tolerance can affect the width of the frame peripheral gap. Also for example, cell size tolerance (Considered process tolerance like cell cutting, side sealing thickness, etc.) can affect the width of the frame peripheral gap. Also for example, guide panel size tolerance can affect the width of the frame peripheral gap. Also for example, assembly tolerance (such as the cell on the backlight), can affect the width of the frame peripheral gap. Also for example, the design gap between the guide panel and the middle frame (which can move during transfer and assembly) can affect the width of the frame peripheral gap. Accordingly, often the frame periphery gap cannot be minimized unless the frame structure design is changed.

Various aspects of the present disclosure include an appreciation that many known borderless display device designs are based on using additional cover glass. With these designs, a black edge is added to the periphery of the cover glass, such as via printing, and the cover glass is attached to a display device frame via adhesive such as double sided tape, However, with these designs, the cost of fabricating such as a display device is often increased.

Accordingly, a system and method are disclosed for providing an information handling system display device with a display device borderless polarizer system. In certain embodiments, the display device borderless polarizer system performs a display device borderless polarizer operation. In certain embodiments, the display device borderless polarizer system implements a cover glass layer which includes a polarizer edge. In certain embodiments, the display device borderless polarizer system minimizes a frame periphery gap of the display device.

More specifically, in certain embodiments, the display device polarizer system increases the length of a front polarizer component. In certain embodiments the front polarizer component includes a slanted cutting edge. In certain embodiments, the slanted cutting edge of the polarizer component mates with a slanted edge of the display device outer frame. In certain embodiments, the display device polarizer system applies black printing under a periphery edge of the front polarizer component.

In certain embodiments, the display device polarizer system includes a surface treatment of photoelectrical material along the periphery edge of the front polarizer component. In certain embodiments, the surface treatment includes a silicon surface treatment, a selenium surface treatment, or a combination thereof. In certain embodiments, the surface treatment results in the application of static electricity between the polarizer and middle frame on the edge of polarizer so that causes static.

In operation, when a light wave (such as from the backlight of the display device) is incident on the polarizer surface then electrons ejected from the surface result in a photoelectric effect. In certain embodiments, this causes static electricity between the polarizer surface and the middle frame. Accordingly, the polarizer attaches to the middle frame automatically whenever the backlight is active.

In certain embodiments, the display device polarizer system advantageously enables removal of a side sealing component. In certain embodiments, the display device polarizer system advantageously enables the polarizer edge to attach to a middle frame whenever the backlight is activated.

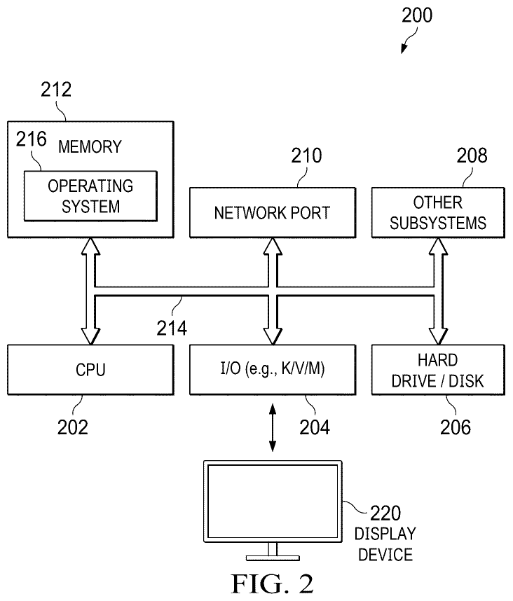

FIG. 2 is a generalized illustration of an information handling system 200 that can be used to implement the system and method of the present invention. The information handling system 200 includes a processor (e.g., central processor unit or “CPU”) 202, input/output (I/O) devices 204, such as a display, a keyboard, a mouse, a touchpad or touchscreen, and associated controllers, a hard drive or disk storage 206, and various other subsystems 208. In various embodiments, the information handling system 200 also includes network port 210 operable to connect to a network 240, which is likewise accessible by a service provider server 242. The information handling system 200 likewise includes system memory 212, which is interconnected to the foregoing via one or more buses 214. System memory 212 further comprises operating system (OS) 216. In various embodiments, the information handling system 200 is coupled with and communicates with a display device 220. In various embodiments, the information handling system is integrated with the display device to provide an all in one (AIO) type information handling system. In certain embodiments, the information handling system includes a portable information handling system which includes an integrated display device.

In certain embodiments, the display device 220 includes a display device borderless polarizer system. In certain embodiments, the display device borderless polarizer system performs a display device borderless polarizer operation. In certain embodiments, the display device borderless polarizer system implements a cover glass layer which includes a polarizer edge.

More specifically, in certain embodiments, the display device polarizer system increases the length of a front polarizer component. In certain embodiments the front polarizer component includes a slanted cutting edge. In certain embodiments, the slanted cutting edge of the polarizer component mates with a slanted edge of the display device outer frame. In certain embodiments, the display device polarizer system applies black printing under a periphery edge of the front polarizer component.

In certain embodiments, the display device polarizer system includes a surface treatment of photoelectrical material along the periphery edge of the front polarizer component. In certain embodiments, the surface treatment includes a silicon surface treatment, a selenium surface treatment, or a combination thereof. In certain embodiments, the surface treatment results in the application of static electricity between polarizer and middle frame on the edge of polarizer so that causes static.

In operation, when a light wave (such as from the backlight of the display device) is incident on the polarizer surface then electrons ejected from the surface result in a photoelectric effect. In certain embodiments, this causes static electricity between the polarizer surface and the middle frame. Accordingly, the polarizer attaches to the middle frame automatically whenever the backlight is active.

In certain embodiments, the display device polarizer system advantageously enables removal of a side sealing component. In certain embodiments, the display device polarizer system advantageously enables the polarizer edge to attach to middle frame whenever the backlight is activated. In certain embodiments, the display device borderless polarizer system advantageously minimizes a frame periphery gap of the display device.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

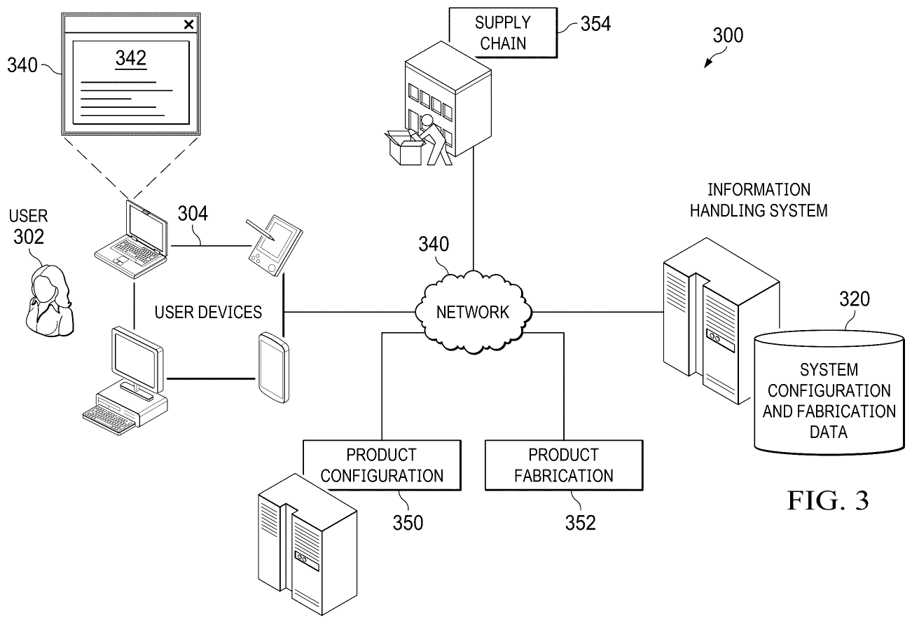

FIG. 3 is a block diagram of an information handling system configuration and fabrication environment 300 implemented in accordance with an embodiment of the invention. In certain embodiments, the information handling system configuration and fabrication environment 300 may include a repository of information handling system configuration and fabrication data 320. In certain embodiments, the repository of information handling system configuration and fabrication data 320 may be local or may be executed remotely.

In certain embodiments, the user device 304 is used to exchange information between the user 302 and a product configuration system 350, and a custom product fabrication system 350, through the use of a network 340. In certain embodiments, the network 340 may be a public network, such as a public internet protocol (IP) network, a physical private network, a wireless network, a virtual private network (VPN), or any combination thereof. Skilled practitioners of the art will recognize that many such embodiments are possible, and the foregoing is not intended to limit the spirit, scope or intent of the invention. As used herein, a user device 304 refers to an information handling system such as a personal computer, a laptop computer, a tablet computer, a personal digital assistant (PDA), a smart phone, a mobile telephone, or other device that is capable of communicating and processing data. In certain embodiments, the user device 304 may be configured to present a configuration and/or fabrication system user interface (UI) 340. In certain embodiments, the configuration and/or fabrication system UI 340 may be implemented to present a graphical representation 342 of configuration and/or fabrication information.

In various embodiments, the configuration and/or fabrication system UI 340 may be presented via a website. In certain embodiments, the website may be provided by the product configuration system 350. For the purposes of this disclosure, a website may be defined as a collection of related web pages which are identified with a common domain name and is published on at least one web server. A website may be accessible via a public IP network or a private local network.

A web page is a document which is accessible via a browser which displays the web page via a display device of an information handling system. In various embodiments, the web page also includes the file which causes the document to be presented via the browser. In various embodiments, the web page may comprise a static web page, which is delivered exactly as stored and a dynamic web page, which is generated by a web application that is driven by software that enhances the web page via user input to a web server.

In certain embodiments, the user device 304 may be implemented to interact with the product configuration system 350, which in turn may be executing on a separate information handling system 300. In various embodiments, the product configuration system 350 interacts with a custom product fabrication system 352. In various embodiments, the custom product fabrication system 352 fabricates products. In various embodiments, the fabricated product includes a display device. In various embodiments, the display device includes a display device borderless polarizer system.

FIG. 4 shows a front view of a display device 400. In certain embodiments, the display device 400 corresponds to display device 220. In certain embodiments, the display device 400 includes a display device borderless polarizer system. In certain embodiments, the display device borderless polarizer system performs a display device borderless polarizer operation. In certain embodiments, the display device borderless polarizer system implements a cover glass layer which includes a polarizer edge. In certain embodiments, the display device borderless polarizer system minimizes a frame periphery gap of the display device.

More specifically, in certain embodiments, the display device polarizer system increases the length of a front polarizer component. In certain embodiments the front polarizer component includes a slanted cutting edge. In certain embodiments, the slanted cutting edge of the polarizer component mates with a slanted edge of the display device outer frame. In certain embodiments, the display device polarizer system applies black printing under a periphery edge of the front polarizer component.

In certain embodiments, the display device polarizer system includes a surface treatment of photoelectrical material along the periphery edge of the front polarizer component. In certain embodiments, the surface treatment includes a silicon surface treatment, a selenium surface treatment, or a combination thereof. In certain embodiments, the surface treatment results in the application of static electricity between polarizer and middle frame on the edge of polarizer so that causes static.

In operation, when a light wave (such as from the backlight of the display device) is incident on the polarizer surface then electrons ejected from the surface result in a photoelectric effect. In certain embodiments, this causes static electricity between the polarizer surface and the middle frame. Accordingly, the polarizer attaches to the middle frame automatically whenever the backlight is active.

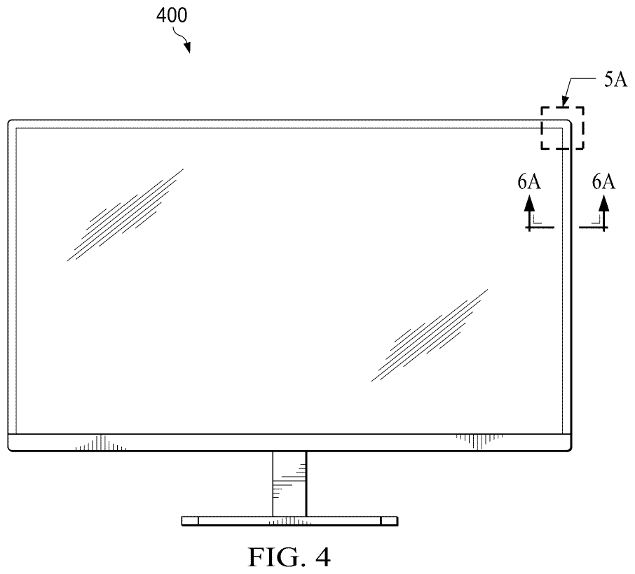

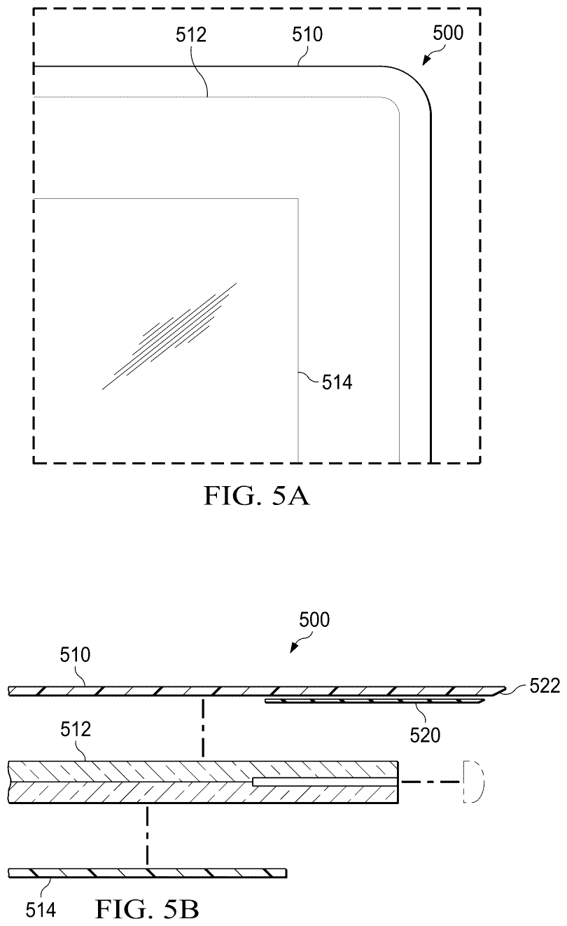

FIGS. 5A and 5B, generally referred to as FIG. 5, respectively show a corner view of a portion of a display device 500 and a cross sectional view of a portion of a display device 500. In certain embodiments, the display device includes a display device borderless polarizer system. In certain embodiments, the display device borderless polarizer system performs a display device borderless polarizer operation. In certain embodiments, the display device borderless polarizer system implements a cover glass layer which includes a polarizer edge.

In certain embodiments, the display device borderless polarizer system includes a front polarizer component 510, a display cell portion 512, a rear polarizer component 514, or a combination thereof. In certain embodiments, the front polarizer component 510 is wider than, taller than, or a combination thereof, the rear polarizer component 514. In certain embodiments, the front polarizer component 510 being wider and taller than the rear polarizer component 514

In certain embodiments, the front polarizer component 510 includes a dark printed surface 520 extending around the periphery of the front polarizer component 510. In certain embodiments, the dark printed surface 520 is black. In certain embodiments, an interior edge of the dark printed surface 520 is substantially parallel with an exterior edge of the rear polarizer component 514.

In certain embodiments, the front polarizer component 510 includes a slanted edge 522 extending around the periphery of the front polarizer component 510. In certain embodiments, the slanted edge 522 includes a slanted cutting edge. In certain embodiments the front polarizer component includes a slanted cutting edge. In certain embodiments, the slanted cutting edge 522 of the front polarizer component 510 mates with a slanted edge of the display device outer frame. In certain embodiments, by mating the slanted cutting edge 522 of the front polarizer component 510 with the slanted edge of the display device outer frame, the display device borderless polarizer system does not need a side sealing element like what was used in known display devices.

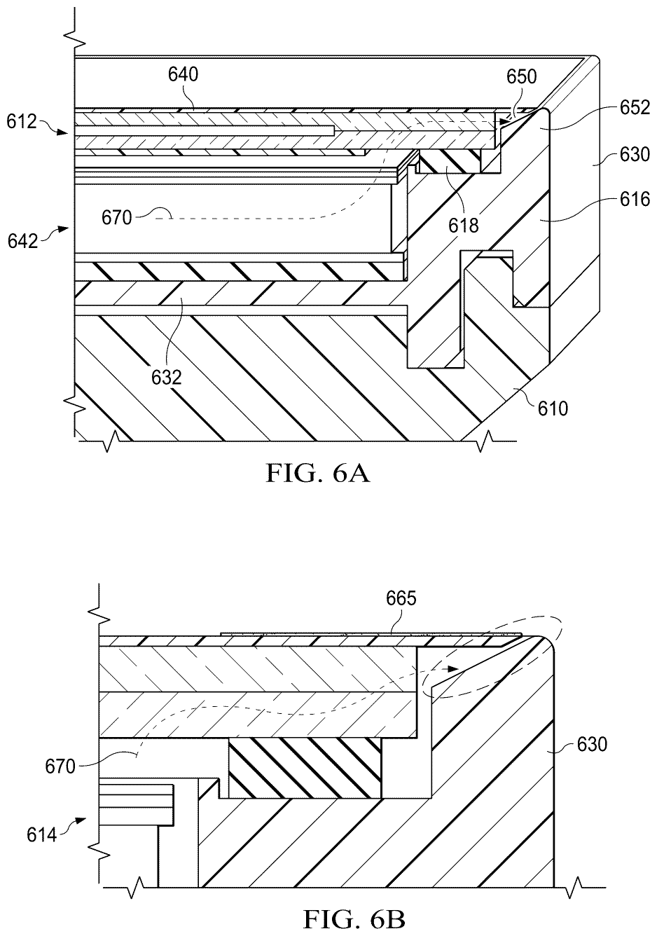

FIGS. 6A and 6B, generally referred to as FIG. 6, respectively show a cross sectional perspective view and a cross sectional view of a portion of a display device 600. In certain embodiments, the display device 600 includes a rear frame portion 610, an open cell LCD component 612, an optical sheets component 614, a middle frame component 616 and a system frame mounting component 618. In certain embodiments, the middle frame component 616 includes an integrated mold frame. In certain embodiments, the middle frame 616 is configured to physically mate with the rear frame portion 610. In certain embodiments, the middle frame component 616 includes an exterior edge portion 630 and an optical sheets support portion 632. In certain embodiments, the exterior edge portion 630 extends substantially (i.e., +/−20%) perpendicularly to the optical sheets support portion 632. In certain embodiments, the exterior edge portion 630 extends along a side edge of the outside of the display device 700. In certain embodiments, the optical sheets support portion 632 extends along a side edge of the inside of display device 700. In certain embodiments, the optical sheets support portion 632 is contiguous with an edge of the optical sheets component 614.

In certain embodiments, the display device 600 includes a front polarizer component 640, a rear polarizer component 642, or a combination thereof. In certain embodiments, the front polarizer component 640 is wider than, taller than, or a combination thereof, the rear polarizer component 642. In certain embodiments, the front polarizer component 640 is positioned on top of the open cell LCD component 612. In certain embodiments, the rear polarizer component 642 is positioned below the open cell LCD component 612. In certain embodiments, the front polarizer component 640 is contiguous with a portion of a top surface of the open cell LCD component 612. In certain embodiments, the rear polarizer component 642 is contiguous with a portion a bottom surface of the open cell LCD component 612. In certain embodiments, the front polarizer component 640 and the rear polarizer component 642 providing the display device with a polarizer edge which extends along a periphery of the LCD component 612.

In certain embodiments, the front polarizer component 640 includes a dark printed surface extending around the periphery of the front polarizer component 640. In certain embodiments, the dark printed surface is black. In certain embodiments, an interior edge of the dark printed surface is substantially parallel with an exterior edge of the rear polarizer component 642.

In certain embodiments, the front polarizer component 640 includes a slanted edge 650 extending around the periphery of the front polarizer component 640. In certain embodiments, the slanted edge 650 includes a slanted cutting edge. In certain embodiments, the front polarizer component 640 includes the slanted cutting edge. In certain embodiments, the slanted cutting edge of the front polarizer component 650 abuts a slanted edge 660 of the middle frame component 616. In certain embodiments, the slanted cutting edge 522 of the front polarizer component 510 abutting the slanted edge 652 of the middle frame component 616, the display device borderless polarizer system provides a side sealing light seal function. In certain embodiments, by the slanted cutting edge 522 of the front polarizer component 510 abutting the slanted edge 652 of the middle frame component 616, the display device borderless polarizer system does not need a side sealing element like what was used in known display devices.

In certain embodiments, the display device polarizer system includes a surface treatment of photoelectrical material 665 along the periphery edge of the front polarizer component 640. In certain embodiments, the surface treatment 665 includes a silicon surface treatment, a selenium surface treatment, or a combination thereof. In certain embodiments, the surface treatment 665 results in the application of static electricity between polarizer and middle frame on the edge of polarizer so that causes static.

In operation, when a light wave 670 (such as from the backlight of the display device) is incident on the polarizer surface, then electrons ejected from the surface result in a photoelectric effect. In certain embodiments, this causes static electricity between the polarizer surface 660 and the middle frame component 616. Accordingly, the polarizer attaches to the middle frame component 616 automatically whenever the backlight is active.

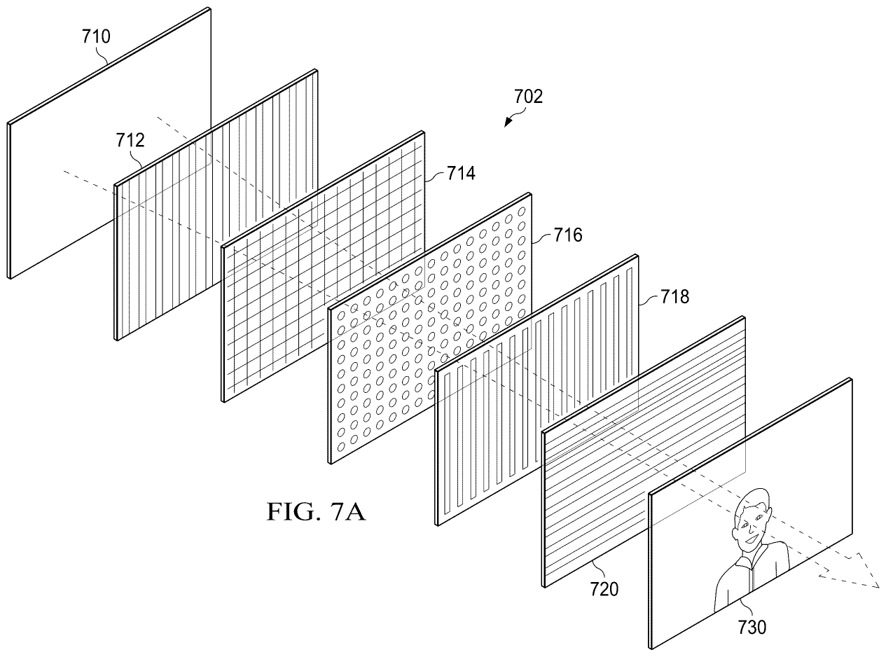

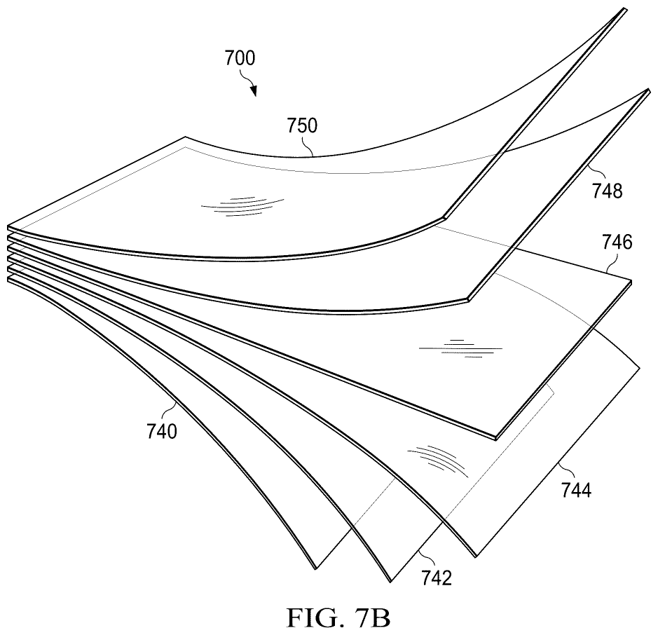

FIGS. 7A and 7B, generally referred to as FIG. 7, respectively show an exploded view of an LCD lighting process and a fanned out view of a polarizer structure 700 of a display device. More specifically, referring to FIG. 7A, in certain embodiments, the display device includes an open-cell LCD component 702. In certain embodiments, the open-cell LCD component 702 includes a back light component 710, a rear polarizer component 712, a thin film transistor (tft) component 714, a cell component 716, a color filter component 718, a front polarizer component 720, or a combination thereof. In certain embodiments, the back light component 710, the rear polarizer component 712, the thin film transistor (tft) component 714, the cell component 716, the color filter component 718, the front polarizer component 720, or a combination thereof, function in combination to generate an image 730 on the display device. In certain embodiments, the back light component 710, the rear polarizer component 712, the thin film transistor (tft) component 714, the cell component 716, the color filter component 718, the front polarizer component 720, or a combination thereof, provide a narrow bezel display device.

Referring now to FIG. 7B, the display device polarizer structure 700 includes an adhesive protection component 740, an adhesive component 742, polarizing component protection component 744, a polarizing component 746, a polarizing component protection component 748 and a surface protection component 750. In certain embodiments, the adhesive protection component 740 includes a release film. In certain embodiments, the pressure sensitive adhesive (PSA) component 742 includes a pressure sensitive adhesive (PSA). In certain embodiments, the polarizing component protection component 744 includes a cellulose material. In certain embodiments, the cellulose material includes a tri-acetyl cellulose (TAC) material. In certain embodiments, the polarizing component 746 includes an alcohol type material. In certain embodiments, the alcohol type material includes a poly Vinyl Alcohol (PVA) material. In certain embodiments, the polarizing component protection component 748 includes a cellulose material. In certain embodiments, the cellulose material includes a tri-acetyl cellulose (TAC) material. In certain embodiments, the surface protection component 750 includes a protective film.

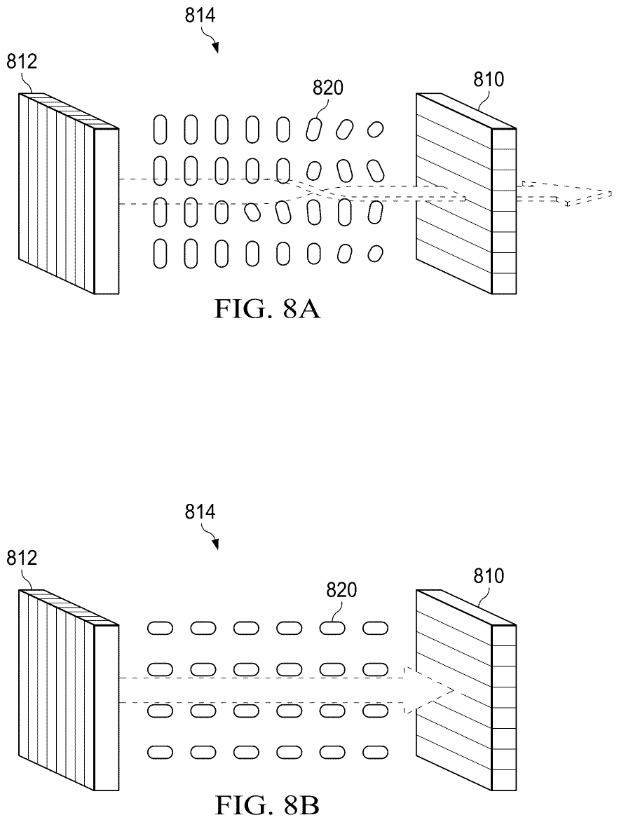

FIGS. 8A and 8B, generally referred to as FIG. 8, show operational views of a polarizer structure 800 of a display device. In certain embodiments, the polarizer structure 800 includes a first polarizer component 810, a second polarizer component 812, a liquid crystal portion 814, or a combination thereof. In certain embodiments, the first polarizer component 810 corresponds to the front polarizer component 510. In certain embodiments, the second polarizer component 812 corresponds to the rear polarizer component 514. In certain embodiments, the liquid crystal portion 814 corresponds to a portion of the display cell portion 512.

In operation, when the first polarizer component 810 and the second polarizer component 814 are inactive, liquid crystal molecules 820 contained within the liquid crystal portion 814 are maintained in a twisted liquid crystal molecule orientation (See e.g., FIG. 8A). Maintaining the liquid crystal molecules 820 contained within the liquid crystal portion 814 in a twisted liquid crystal molecule orientation allows light to pass through the polarizer structure 800. When the first polarizer component 810 and the second polarizer component 814 are active, liquid crystal molecules 820 contained within the liquid crystal portion 814 are maintained in an organized liquid crystal molecule orientation (See e.g., FIG. 8B). When the liquid crystal molecules 820 are maintained in an organized liquid crystal molecule orientation, the liquid crystal molecules 820 are effectively line-up with each other. Maintaining the liquid crystal molecules 820 contained within the liquid crystal portion 814 in an organized liquid crystal molecule orientation prevents light to pass through the polarizer structure 800.

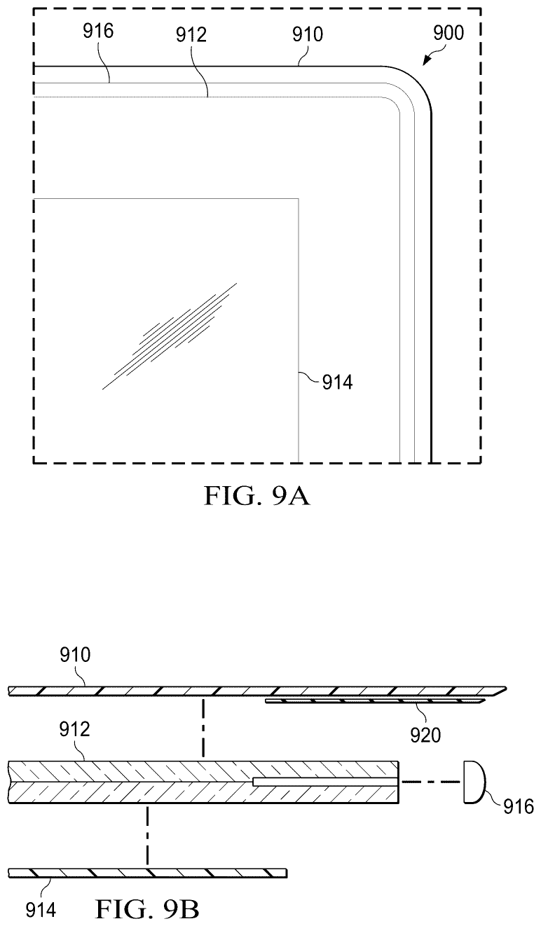

FIGS. 9A and 9B, generally referred to as FIG. 9, respectively show a corner view of a portion of an alternate display device and a cross sectional view of a portion of an alternate display device 900.

In certain embodiments, the display device includes a display device borderless polarizer system. In certain embodiments, the display device borderless polarizer system performs a display device borderless polarizer operation. In certain embodiments, the display device borderless polarizer system implements a cover glass layer which includes a polarizer edge.

In certain embodiments, the display device borderless polarizer system includes a front polarizer component 910, a display cell portion 912, a rear polarizer component 914, or a combination thereof. In certain embodiments, the front polarizer component 910 is wider than, taller than, or a combination thereof, the rear polarizer component 914. In certain embodiments, the display cell portion 912 includes a side sealing element 916. In certain embodiments, the side sealing element 916 extends across the periphery of the display cell portion 912.

In certain embodiments, the front polarizer component 910 includes a dark printed surface 920 extending around the periphery of the front polarizer component 910. In certain embodiments, the dark printed surface 920 is black. In certain embodiments, an interior edge of the dark printed surface 920 is substantially (i.e., +/−20%) parallel with an exterior edge of the rear polarizer component 914.

In certain embodiments, the front polarizer component 910 includes a slanted edge 922 extending around the periphery of the front polarizer component 910. In certain embodiments, the slanted edge 922 includes a slanted cutting edge. In certain embodiments the front polarizer component includes a slanted cutting edge. In certain embodiments, the slanted cutting edge 922 of the front polarizer component 910 mates with a slanted edge of the display device outer frame.

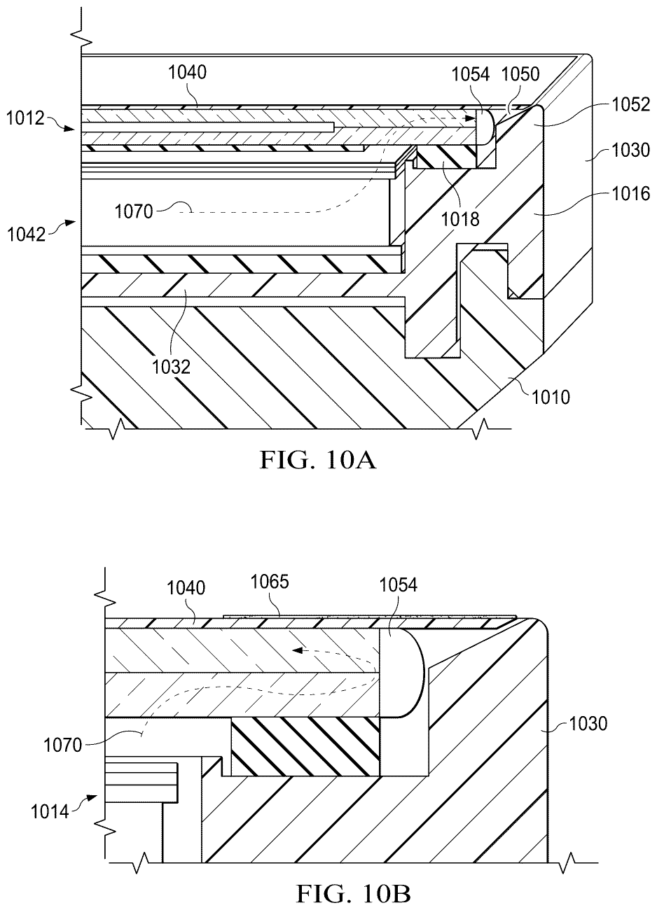

FIGS. 10A and 10B, generally referred to as FIG. 10, respectively show a cross sectional perspective view and a cross sectional view of a portion of an alternate display device 1000. In certain embodiments, the display device 1000 includes a rear frame portion 1010, an open cell LCD component 1012, an optical sheets component 1014, a middle frame component 1016 and a system frame mounting component 1018.

In certain embodiments, the middle frame component 1016 includes an integrated mold frame. In certain embodiments, the middle frame 1016 is configured to physically mate with the rear frame portion 1010. In certain embodiments, the middle frame component 1016 includes an exterior edge portion 1030 and an optical sheets support portion 1032. In certain embodiments, the exterior edge portion 1030 extends substantially (i.e., +/−20%) perpendicularly to the optical sheets support portion 1032. In certain embodiments, the exterior edge portion 1030 extends along a side edge of the outside of the display device 700. In certain embodiments, the optical sheets support portion 1032 extends along a side edge of the inside of display device 700. In certain embodiments, the optical sheets support portion 1032 is contiguous with an edge of the optical sheets component 1014.

In certain embodiments, the display device 1000 includes a front polarizer component 1040, a rear polarizer component 1042, or a combination thereof. In certain embodiments, the front polarizer component 1040 is wider than, taller than, or a combination thereof, the rear polarizer component 1042. In certain embodiments, the front polarizer component 1040 is positioned on top of the open cell LCD component 1012. In certain embodiments, the rear polarizer component 1042 is positioned below the open cell LCD component 1012. In certain embodiments, the front polarizer component 1040 is contiguous with a top surface of the open cell LCD component 1012. In certain embodiments, the rear polarizer component 1042 is contiguous with a bottom surface of the open cell LCD component 1012.

In certain embodiments, the front polarizer component 1040 includes a dark printed surface extending around the periphery of the front polarizer component 1040. In certain embodiments, the dark printed surface is black. In certain embodiments, an interior edge of the dark printed surface is substantially parallel with an exterior edge of the rear polarizer component 1042.

In certain embodiments, the front polarizer component 1040 includes a slanted edge 1050 extending around the periphery of the front polarizer component 1040. In certain embodiments, the slanted edge 1050 includes a slanted cutting edge. In certain embodiments, the front polarizer component 1040 includes the slanted cutting edge. In certain embodiments, the slanted cutting edge of the front polarizer component 1050 mates with a slanted edge 1060 of the middle frame component 1016. In certain embodiments, the display device borderless polarizer system includes a side sealing element 1052.

In certain embodiments, the display device polarizer system includes a surface treatment of photoelectrical material 1065 along the periphery edge of the front polarizer component 1040. In certain embodiments, the surface treatment 1065 includes a silicon surface treatment, a selenium surface treatment, or a combination thereof. In certain embodiments, the surface treatment 1065 results in the application of static electricity between polarizer and middle frame on the edge of polarizer so that causes static.

In operation, when a light wave 1070 (such as from the backlight of the display device) is incident on the polarizer surface, then electrons ejected from the surface result in a photoelectric effect. In certain embodiments, this causes static electricity between the polarizer surface 1060 and the middle frame component 1016. Accordingly, the polarizer attaches to the middle frame component 1016 automatically whenever the backlight is active.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A borderless polarizer system for a display device comprising:
a display cell component;
a front polarizer component, the front polarizer component being contiguous with a portion of a top surface of the display cell component; and,
a rear polarizer component, the rear polarizer component being contiguous with a portion of a bottom surface of the display cell component, the front polarizer component and the rear polarizer component providing a polarizer edge, the polarizer edge extending extends along a periphery of the display cell component.

2. The borderless polarizer system of claim 1, wherein:
the front polarizer component includes a slanted edge, the slanted edge extending along a periphery of the front polarizer component.

3. The borderless polarizer system of claim 2, wherein:
the display device includes a middle frame component, the middle frame component including a slanted edge; and,
the slanted edge of the front polarizer component abutting a slanted edge of the middle frame component.

4. The borderless polarizer system of claim 1, wherein:
the front polarizer component includes a dark printed surface, the dark printed surface extending along a periphery of the front polarizer component.

5. The borderless polarizer system of claim 4, wherein:
an interior edge of the dark printed surface is substantially parallel with an exterior edge of the rear polarizer component.

6. The borderless polarizer system of claim 1, wherein:
the display cell component includes an associated side sealing element, the side sealing element extending along a periphery of the display cell component.

7. A display device comprising:
an optical sheets component; and,
a borderless polarizer system, the borderless polarizer system comprising
a display cell component;
a front polarizer component, the front polarizer component being contiguous with a portion of a top surface of the display cell component; and,
a rear polarizer component, the rear polarizer component being contiguous with a portion of a bottom surface of the display cell component, the front polarizer component and the rear polarizer component providing a polarizer edge, the polarizer edge extending extends along a periphery of the display cell component.

8. The display device of claim 7, wherein:
the front polarizer component includes a slanted edge, the slanted edge extending along a periphery of the front polarizer component.

9. The display device of claim 8, wherein:
the display device includes a middle frame component, the middle frame component including a slanted edge; and,
the slanted edge of the front polarizer component abutting a slanted edge of the middle frame component.

10. The display device of claim 7, wherein:
the front polarizer component includes a dark printed surface, the dark printed surface extending along a periphery of the front polarizer component.

11. The display device of claim 10, wherein:
an interior edge of the dark printed surface is substantially parallel with an exterior edge of the rear polarizer component.

12. The display device of claim 7, wherein:
the display cell component includes an associated side sealing element, the side sealing element extending along a periphery of the display cell component.

13. A system comprising:
a processor;
a data bus coupled to the processor; and
a display device comprising
an optical sheets component; and,
a borderless polarizer system, the borderless polarizer system comprising
a display cell component;
a front polarizer component, the front polarizer component being contiguous with a portion of a top surface of the display cell component; and,
a rear polarizer component, the rear polarizer component being contiguous with a portion of a bottom surface of the display cell component, the front polarizer component and the rear polarizer component providing a polarizer edge, the polarizer edge extending extends along a periphery of the display cell component.

14. The system of claim 13, wherein:
the front polarizer component includes a slanted edge, the slanted edge extending along a periphery of the front polarizer component.

15. The system of claim 14, wherein:
the display device includes a middle frame component, the middle frame component including a slanted edge; and,
the slanted edge of the front polarizer component abutting a slanted edge of the middle frame component.

16. The system of claim 13, wherein:
the front polarizer component includes a dark printed surface, the dark printed surface extending along a periphery of the front polarizer component.

17. The system of claim 16, wherein:
an interior edge of the dark printed surface is substantially parallel with an exterior edge of the rear polarizer component.

18. The system of claim 13, wherein:
the display cell component includes an associated side sealing element, the side sealing element extending along a periphery of the display cell component.
